(19) United States
(12) Patent Application Publication
(10) Pub. No.: US 2006/0206405 A1
(43) Pub. Date: Sep. 14, 2006

(54) Gambill stock oscillator

(76) Inventor: Scott Gambill, Eagan, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/078,463

(22) Filed: Mar. 11, 2005

(51) Int. Cl. G06Q 40/00

(52) U.S. Cl. 705/37

(57) ABSTRACT

Described are methods of using “insider” transactions for purchases and sales of stock equities, as reported in Form 4 filings with the United States Securities and Exchange Commission, in a method of gauging valuation of a group of stocks or a general market of stocks.

### FIELD OF THE INVENTION

The invention relates to a mathematic indicator for use in selecting equities, and related methods.

### BACKGROUND

The investing community uses myriad tools for picking stocks, some of which may be more effective than others. Certain indicators of stock value attempt to objectively measure present value of individual stocks. These might include such basic indicators as price to earnings ratio, price to sales ratio, dividend yield, or other objective measures of a company's financial health or value. Certain other indicators may be used for shorter-term trading of a single stock, based on data relating to trades made in a company's stock, such as stock price movements, trading volumes, or price momentum. These indicators may include, for example, “Bollinger Bands”; a “Stochastic Oscillator,” which may be “fast” or “slow”; “McClellan Oscillator”; stock price moving averages, etc.

Other indicators used in assessing whether to buy or sell individual stocks may relate not to financial or trading information of a single stock but to general market conditions. An investor or trader may consider whether an entire group of stocks, such as an index, is at an unordinarily high or low valuation, in considering whether to buy stocks of that group. By such a method, indicators such as price to earnings, price to sales, Bollinger Bands, Stochastic and McClellan Oscillators, may be applied to a bundle of stocks or a basket of stocks in a stock index. If the indication is of a favorable value, an investor may purchase one or more of the stocks of the group. Examples of stock indices include the Dow Jones Industrial Index of 30 industrial companies, the Standard & Poor 500, the Willshire 5000, and the Russell 3000. A multitude of other such stock indices also exist.

Another indicator used by traders and investors is what is referred to as “insider” trading activity. According to (the United States) Security & Exchange Commission (SEC) regulations, the “insiders” of a corporation, i.e., officers, directors, and controlling shareholders of publicly traded companies, are required to disclose changes in their ownership of a company by filing the SEC Form 4. Before October of 2002, these disclosures were required to be made within 10 business days of the month following any such transaction. The rules allowed for delays of days or many weeks between a trade by an “insider,” and dissemination of the trade to investors. This delay would limit the value of the underlying information.

### SUMMARY

With the enactment of the Sarbanes/Oxley Act of 2002, the reporting window for reporting insider transactions was narrowed to two business days following any transaction by an “insider.” Expedition of reporting such transactions was further advanced in July of 2003 with the subsequent condition that all Form 4 filings be made electronically. As a result, insider trading as reported in SEC Form 4s has now become much more transparent, reliable, and near real-time in nature. The opportunity this presents is that a timely aggregation of this data can be lined up against the underlying basket of equities that make up the U.S. market to gauge their value as seen through the collective eye of corporate insiders.

The invention relates to the use of data of purchases or sales of equities in publicly traded companies, by officers, directors, and controlling shareholders of a company, referred to as “insider transactions.” The data comes from Form 4 filings with the Securities and Exchange Commission. These filings are reported by public News media within a matter of days of the transaction.

The invention relates to the use of information relating to insider trading transactions, to identify favorable opportunities to purchase (or sell) securities. According to the invention, Form 4 filings are reviewed and sorted to omit those Form 4 filings that do not indicate a favorable opportunity to purchase or sell a type of security. This may mean that Form 4 filings are sorted to omit transactions that are not of companies within a specific type or index of stocks, e.g., Form 4 filings that are not of stocks in the Russell 3000 index (or another index) may be omitted. Form 4 filings that contain other information may also be omitted, such as information that is not sufficiently recent, information that relates to an amendment of an earlier transaction, or purchase (or sell) transactions by an “insider” that is otherwise less likely to indicate that the purchaser is buying (or selling) based on an understanding by the individual that the stock price will move in an up or down direction (e.g., non-open market transactions). After those Form 4 transactions are omitted from all submitted Form 4s, for each company or security for which at least one Form 4 remains, the number of shares reported as sold (for an equity) is subtracted from the total number of shares reported as purchased (for the equity). There will be some securities that calculate to have a net positive number of purchases (“net buy securities”), and there will be some securities that calculate to have a net negative number of purchases (“net sale securities”). The ratio of net buy securities to net sale securities (“oscillator value”) can be calculated for a given period, such as for a single day, a number of days, or a week or month. Any number of oscillator value calculations may then be averaged, if desired. The oscillator value can be calculated, monitored, graphed, and compared to or used with other indicia of stock market or individual stock price valuations to make decisions on buying or selling individual stocks or bundles of stocks.

An aspect of the invention relates to a method of evaluating financial securities. The method involves: identifying all buy and sell transactions during a given period of time for a group of securities in the form of insider trades as reported by Form 4 submissions to the Security and Exchange Commission; omitting transactions that are submitted as Form 4 amendments and that are submitted by a controlling shareholders who is not an officer or director of the security company; for each individual security of which one or more Form 4 submission was made, subtracting the total number of shares reported to be sold from the total number of shares reported to be purchased; identifying the number of securities that have a net number of shares purchased; identifying the number of securities that have a net number of shares sold; and dividing the number of securities that have a net number of shares purchased by the number of securities that have a net number of shares sold, to calculate a periodic oscillator value. The result is the Gambill Oscillator.

Another aspect of the invention relates to a stock market indicator calculated as a ratio of: from a group of stocks, the number of stocks of the group that have net buying activity by insiders over the number of stocks of the group that have net selling activity by insiders. The number of stocks of the group having net buying activity by insiders is the total number of stocks in the group that have more shares purchased than sold as reported by all Security and Exchange Commission Form 4 submissions for a security during a given time period, excluding Form 4 submissions that are Form 4 amendments to earlier transactions, Form 4 submissions for non-open market transactions, and Form 4 submissions from controlling shareholders not also officers or directors of the security company. The number of stocks of the group having net selling activity by insiders is the total number of stocks in the group that have more shares sold than purchased as reported by all Security and Exchange Commission Form 4 submissions for a security during a given time period, excluding Form 4 submissions that are Form 4 amendments to earlier transactions, Form 4 submissions for non-open market transactions, and Form 4 submissions from controlling shareholders not also officers or directors of the security company.

### BRIEF DESCRIPTION OF THE FIGURES

FIG. 1 is a graph of the Standard and Poor 500 stock index versus the Gambill Oscillator.

### DETAILED DESCRIPTION

The invention starts with raw data, for a time period, of all Form 4 filings made with the United States Securities & Exchange Commission. As an example, methods of the invention can begin with all Form 4 filings from a one day period as reported by a public news outlet such as the Dow Jones News Service, Reuters, etc. Each Form 4 filing includes information such as the name of the party or individual making a stock buy or sell transaction, the type of insider that person is considered (director, officer, controlling shareholder), the type of transaction (buy or sell, “market” or “non-market”); and the price and number of shares of the transaction. The insider trading information is to have been filed electronically by a corporate insider, i.e., officer, director, or controlling shareholder, within two days of the transaction. Thus, the public reporting of the transaction should be recent within a few days.

From this raw data, e.g., all Form 4 filings for a period, are removed the filings that are considered to be less pertinent or not pertinent in assessing the value of underlying stock securities. For example, the total of Form 4 filings relate to buy and sell transactions of various types of publicly trades securities, including U.S. corporations, non-U.S. corporations (“foreign” corporations), partnerships, etc. According to specific embodiments of the invention, a user of the method may be interested in only purchasing or selling securities from a certain group or class of securities, e.g., U.S. stocks. Thus, the Form 4 filings that do not relate to the selected group or class can be removed.

Examples of groups or classes of stocks that may be useful to review according to the invention may be various groups of U.S. stocks, such as “Large Cap” stocks (e.g., Dow Jones Industrials), “Small Cap” stocks (e.g., the Russell 2000 index); stocks of a specific sector (Energy, Financial Sector, Healthcare, Real Estate, Technology, Telecommunications, Utilities); or stocks of the entire U.S. stock market (e.g., as measured by the Russell 3000 index or Willshire 5000 index). The Russell 3000 is composed of the 3000 largest U.S. corporations as measured by market capitalization. The current Russell 3000 Index reflects approximately 98% of the U.S. total market capitalization and is therefore an excellent benchmark for U.S. market analysis.

According to the method of the invention, all Form 4 transactions reported during a specific period (e.g., day) are sorted to isolate members of a select group or type of securities. If this is the group of U.S. securities that represent the U.S. market, the Russell 3000 index can be selected, and all transactions filed with the SEC in a Form 4 that that do not relate to a stock of the Russell 3000 index are removed from the data. This results in the exclusion of transactions that relate to Foreign Corporations, Closed-End Investment Companies, Limited Partnerships, Preferred and Convertible Preferred Stocks, Warrants, Rights, Trust Receipts, Royalty Trusts, Bulletin Board and Pink Sheet stocks.

Other Form 4 filings that may also not be indicative of a favorable market condition can also be removed. One possibility is to remove filings that are by individuals considered insiders, but who are not officers or members of the company's board of directors. In addition to directors and officers, individuals or companies that own a substantial amount of a company's stock are required to report stock transactions with an SEC Form 4 , e.g., such individuals or companies are referred to as “controlling shareholders.” These controlling shareholders may be institutions such as mutual funds, banks, credit unions, retirement plans, individuals, or any other entity that has a large ownership position in the company. Decision by an “insider” to buy or sell stock in the company may not be indicative of a favorable or unfavorable valuation of the company, if the insider is not an officer or a director. As such, the invention allows for and preferably includes omitting Form 4 transactions of controlling shareholders who are not also an officer or director of the company.

Still other Form 4 filings that may not be indicative of a favorable market condition, which can be excluded from the calculation, are Form 4 filings that relate to an amendment of an earlier transaction. Periodically, a Form 4 filing includes an error, such as an error in an amount of stock purchased or sold, or an error in the price reported. A Form 4 amendment is later filed to correct the error. According to the invention, these Form 4 amendments can also be omitted from the total Form 4 submissions for a period of time.

Form 4 transactions identified as non-open market transactions can be and preferably are also excluded as being not indicative of a favorable valuation of a stock. Non-open market transactions are often priced below the open market price of the stock. This results in an unfair motivation for the insider to buy stock at a price which is not available to the outside investor.

All late filings (filings over 90 days old) can also be excluded, and preferably are excluded, from the calculation. Rules require that insiders make Form 4 filings within 2 trading days of a transaction date. Although reports usually are made within this time frame there are occasional late reports that are filed. According to the inventive methods, late filings can be discarded, especially filings that are over 90 days old.

After these steps of omitting certain types of Form 4 filings, the remaining Form 4s are sorted into the transactions of each underlying company. The transactions of each company are then sorted into two groups, by company: those stocks (companies) that had net insider buys, and stocks (companies) that had net insider sells. Stocks that have net insider buys are stocks of a particular company that have a larger number of shares purchased than sold based on all Form 4 filings, during a period (e.g., day), i.e., a positive value results when the number of shares sold is subtracted from the number of shares purchased, in all Form 4 filings. Stocks that have net insider sales are the stocks of a particular company that have a larger number of shares sold than purchased based on all Form 4 filings over a period (e.g., day).

A periodic indicator value, e.g., referred to as an oscillator value, a daily indicator value, etc., can be the ratio of the number of stocks that have net insider buys over the number of stocks that have net insider sales. The oscillator value can indicate either an extreme high or a low value of insider purchasing activity for a selected group or class of stocks, e.g., the U.S. market as measured by the Russell 3000 index. The oscillator value can be calculated, recorded, and monitored over time, e.g., on a daily or weekly basis. The oscillator value, e.g., as calculated daily over time, may optionally be charted and compared to another indicator of individual stock valuation or of market valuation, such as the price activity of a given group or class of stocks (e.g., a proxy for the entire U.S. stock market such as the Standard and Poor 500 index, the Russell 3000 index, the Willshire 5000 index, etc.).

Also optionally, the oscillator value may be averaged out over a given number of periods of the calculation. For example, daily oscillator values may be averaged over a five day period and then charted against an index such as the Standard and Poor 500 index, the Russell 3000 index, the Willshire 5000 index, etc. Taking an average of the daily oscillator value can reduce fluctuation and avoid too soon of a buy or sell signal.

The actual value of the oscillator will be a positive value, because each of the numerator and denominator is positive. Seldom are there more stocks that have net insider buys compared to stocks that have net insider sells. Insider sell transactions are typically more common than insider purchases for a number of possible reasons. For instance, executives and directors often execute sell transactions on an automatic schedule. These individuals sometimes have high amounts of stock in the company and periodically sell a portion per year or quarter.

Because more sell transactions normally are seen than buy transactions, a value for the oscillator of more than 1.0 would be considered relatively high. More typically, a value may be lower than ⅓ (33%) or ¼ (25%). The oscillator value, if sufficiently high compared to historical values, can signal a favorable overall valuation for the stocks used to calculate the oscillator value.

The oscillator value, if relatively low, might also indicate a high valuation, but less typically. The oscillator value is perhaps best at measuring extreme oversold conditions of a total market. Thus, the oscillator value may not be considered to indicate a valuation of any one selected stock or security. Instead, a relatively high oscillator value may be indicative of a desirable valuation of the overall market, which can be used in combination with other indicators or valuation methods to identify an oversold condition or buying opportunity for the market in general or for a component or sector of the market. Likewise, a moderately low or low oscillator value may be indicative of a fair valuation of the market or a high valuation of the market. A low oscillator value may be used in combination with other valuation techniques, e.g., to make more careful purchasing decisions.

### ILLUSTRATION

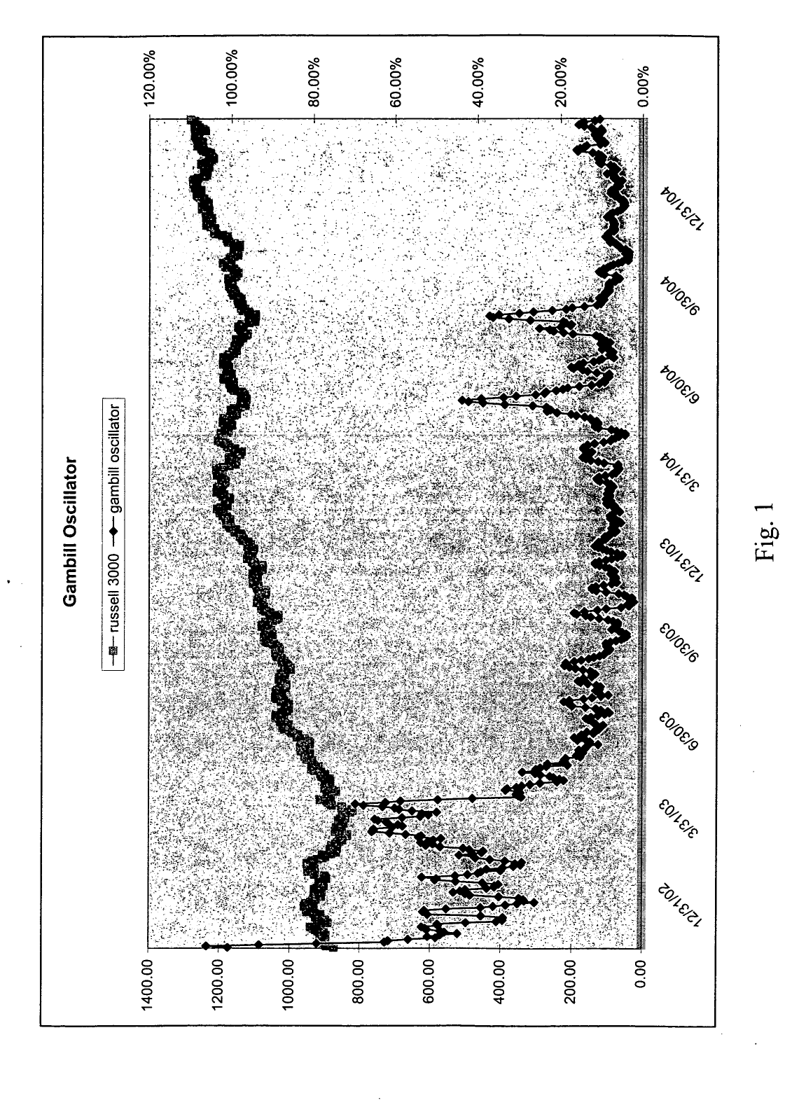

FIG. 1 is a graph of the oscillator as measured by using Form 4 filings from Russell 3000 stocks, excluding Form 4 amendments, “insider” transactions from individuals who are not executives or directors. FIG. 1 also shows the value of the Standard & Poor 500 index of U.S. stock securities. A comparison of the datapoints can be seen to show a correlation between high oscillator value and intermittent lows in the market using the Standard & Poor 500 index as a benchmark.

Media reporting of insider buying to our knowledge has been represented in only two other manners:

1) Company specific reports such as the Barron's “Insider Periscope” or the “Insider Trading Spotlight” of The Wall Street Journal can be helpful in evaluating individual equities but offer no insight into broader market valuations.

2) Aggregate monetary flow. The net flow of Insider money into and out of U.S. equities on a monthly basis as reported by the Dow Jones News Service. Aggregate monthly money flow is problematic not only because the data is latent but also because large insider sell transactions such as those seen monthly by William Gates of Microsoft and Lawrence Ellison of Oracle combined can equal nearly $½ billion in any given month can result in tremendous skewing of the data. As an example, in the month of July 2004, U.S. Insiders sold $1.8 billion worth of stocks as reported by the Dow Jones News Service, however $294,311,764 or 16% of all stocks sales could be attributed exclusively to Gates and Ellison combined.

The Gambill Oscillator can be used alone or in combination with other stock-selection methods, e.g., as a tool in combination with fundamental analysis, technical analysis, or other types of stock or stock market analyses. The Gambill Oscillator may be used as a tool in a manner analogous to other tools or indicators that gauge stock market valuation in general, e.g., a generally favorable or unfavorable market condition. Other such general market gauges may include the Mclellan Oscillator and Stochastic indicators, which both can be used to generally identify market conditions that are overbought or oversold. The Gambill Oscillator may be useful to identify a market that as a general matter is oversold. With the Gambill Oscillator indicating an oversold condition, an investor may purchase stocks of a single equity or may purchase stocks or a fund that tracks a market or a portion of the general stock market.

As opposed to other uses of insider transaction information, the Gambill Oscillator provides an un-weighted near real-time snapshot of equity market valuations. The Gambill Oscillator compares the number of stocks that have net buying activity to the number of stocks that have net sales activity. Neither the total number of actual stock shares bought or sold, nor the total value of shares bought or sold, is used as the direct measure of the oscillator.

1. A method of evaluating financial securities, the method comprising
identifying all buy and sell transactions during a given period of time for a group of securities in the form of insider trades as reported by Form 4 submissions to the Security and Exchange Commission,
omitting transactions that are submitted as Form 4 amendments and that are submitted by controlling shareholders who are not officers or directors of the security company,
for each individual security of which one or more Form 4 submission was made, subtracting the total number of shares reported to be sold from the total number of shares reported to be purchased,
identifying the number of securities that have a net number of shares purchased,
identifying the number of securities that have a net number of shares sold, and
dividing the number of securities that have a net number of shares purchased by the number of securities that have a net number of shares sold, to calculate a periodic oscillator value.

2. The method of claim 1 wherein the period of time is one day, and the method comprises taking an average of the daily result over five days.

3. The method of claim 1 wherein the group of securities is a stock index.

4. The method of claim 3 wherein the index is the Russell 3000.

5. The method of claim 1 comprising graphing the periodic oscillator value over time.

6. The method of claim 5 comprising comparing the graph of the oscillator value to a value of a stock index.

7. The method of claim 6 wherein the stock index is the Russell 3000.

8. The method of claim 1 comprising omitting transactions that are submitted as non-open market transactions.

9. A stock market indicator calculated as a ratio of:from a group of stocks, the number of stocks of the group that have net buying activity by insiders over the number of stocks of the group that have net selling activity by insiders, wherein
the number of stocks of the group having net buying activity by insiders is the total number of stocks in the group that have more shares purchased than sold as reported by all Security and Exchange Commission Form 4 submissions for a security during a given time period, excluding Form 4 submissions that are Form 4 amendments to earlier transactions, Form 4 submissions for non-open market transactions, and Form 4 submissions from controlling shareholders not also officers or directors of the security company, and
the number of stocks of the group having net selling activity by insiders is the total number of stocks in the group that have more shares sold than purchased as reported by all Security and Exchange Commission Form 4 submissions for a security during a given time period, excluding Form 4 submissions that are Form 4 amendments to earlier transactions, Form 4 submissions for non-open market transactions, and Form 4 submissions from controlling shareholders not also officers or directors of the security company.

10. The indicator of claim 9 wherein the group is a stock index.

11. The indicator of claim 10 wherein the index is the Russell 3000 stock index.

12. The indicator of claim 10 wherein the index is the Willshire 5000 stock index.
